(19) United States
(12) Patent Application Publication
(10) Pub. No.: US 2016/0082403 A1
(43) Pub. Date: Mar. 24, 2016

(54) MULTI-COLOR FLUID DISPENSER APPARATUS

(71) Applicant: Younes Ounzar, Dallas, TX (US)

(72) Inventor: Younes Ounzar, Dallas, TX (US)

(21) Appl. No.: 14/800,571

(22) Filed: Jul. 15, 2015

Related U.S. Application Data
(60) Provisional application No. 62/054,971, filed on Sep. 24, 2014.

(51) Int. Cl. B01F 15/02; B01F 7/00; B01F 3/08; A45D 19/00; A45D 34/00

(52) U.S. Cl. CPC B01F 15/0203; A45D 19/00; A45D 34/00; B01F 3/0853; B01F 7/00341; B01F 2215/005

(57) ABSTRACT

A multi-color fluid dispenser apparatus includes a cubical container, multiple cartridge members, a mixing unit, and a user interface. The cartridge members are positioned within the cubical container to store and dispense a different colored fluid via tube members attached to each cartridge member. The mixing unit is in communication with the cartridge members include: a dispenser head comprising multiple openings, where each opening is attached to each tube member to dispense a different colored fluid, and a mixing bowl positioned below the dispenser head to receive one or more of the different colored fluids from the openings of the dispenser head, where the mixing bowl mixes the different colored fluids to generate new colored fluid. The user interface is in communication with the mixing unit and facilitates a user to select the different colored fluids, and dispense the different colored fluids at predefined proportions via the dispenser head.

### BACKGROUND

In most countries, hair coloring is just a part of grooming or styling of an individual, while in some other countries, it's a part of the culture and heritage as well. Conventionally, manual mixing was practiced where a user manually mixes a set of hair colors, for example, herbal or synthetic pigments, to get a desired color. This color was later applied on to the hair. In modern times, machines were used to do the same. A required proportion of the colors were mixed to obtain the desired color. An indicator chart was also displayed which would indicate a specific mix of colors to get a specific color. The colors were either hand squeezed from a flexible cartridge or automatically injected from the cartridge according to the prescribed amount.

The mixed colors were collected in a collecting bowl and additives were added if necessary. Even though such mixing machines enabled a user to decide a color as well as mix a set of colors to obtain a desired different color, they lacked a complete automation. That is, a simplified user interaction with the machine was needed so that an ordinary user can select the desired color easily. Further, when a level of the coloring pigment in the cartridge was low, the user had to manually re-order the specific color with the required quantity from an external vendor. Most conventional mixing machines had to be manually cleaned as well, especially parts like the collection bowl and the cartridge assembly to sustain an efficient reproduction of accurate colors using such mixing machines.

Hence, there is a long felt but unresolved need for a multi-color fluid dispenser apparatus for preparing hair colors, with additional features like capable of self-cleaning, automatically re-order a low level hair coloring pigment, and save a data of user information and their color preferences.

### SUMMARY OF THE INVENTION

The multi-color fluid dispenser apparatus for hair coloring disclosed herein addresses the above stated needs for hair color mixing, self-cleaning of the apparatus, automatic re-ordering of a low level hair coloring pigment, and saving a data of user preferences and their color proportions. The multi-color fluid dispenser apparatus disclosed herein comprises generally cubical container, multiple cartridge members, a mixing unit, and a user interface. The cartridge members are removably positioned on a holder within the cubical container, where each cartridge member is configured to store and dispense a different colored fluid via tube members attached to each cartridge member. The mixing unit is in communication with the cartridge members, and the mixing unit comprises a dispenser head and at least one receptacle such as a mixing bowl.

The dispenser head comprises multiple openings, where each opening is attached to each tube member, and each opening is configured to dispense a different colored fluid. The mixing bowl is positioned below the dispenser head the mixing bowl and is configured to receive one or more of the different colored fluids from one or more of the openings of the dispenser head, where the mixing bowl mixes the different colored fluids to generate new colored fluid. The user interface is controlled by at least one processor and is in communication with the mixing unit. The user interface is configured to facilitate a user to select the one or more different colored fluids, and dispense the one or more different colored fluids at predefined proportions via the dispenser head.

In an embodiment, the multi-color fluid dispenser apparatus disclosed herein further comprises a database in communication with the user interface, where the database is configured to store information regarding personal details of the users and mixing proportions of the colored fluids of each of the respective users. In an embodiment, each mixing proportion of the colored fluids of each user is configured to be modified by the respective user. In an embodiment, the multi-color fluid dispenser apparatus disclosed herein further comprises a color level monitoring module in communication with an external color supplier via a network, where the color level monitoring module transmits information regarding a low level of the colored fluids in one or more of the cartridge members and places an order for the respective colored fluids to the external color supplier.

### BRIEF DESCRIPTION OF THE DRAWINGS

FIG. 1A exemplarily illustrates a bottom perspective view of the multi-color fluid dispenser apparatus.

FIG. 1B exemplarily illustrates a side perspective view of the multi-color fluid dispenser apparatus.

FIG. 2 exemplarily illustrates an exploded view of the multi-color fluid dispenser apparatus.

FIG. 3 exemplarily illustrates a perspective view of the cartridge members positioned in the holder.

FIG. 4 exemplarily illustrates a top perspective view of the cartridge members with the holder and assembled below a top plate.

FIG. 5 exemplarily illustrates a schematic diagram of the working of the color level monitoring module and the external color supplier via the network.

### DETAILED DESCRIPTION OF THE INVENTION

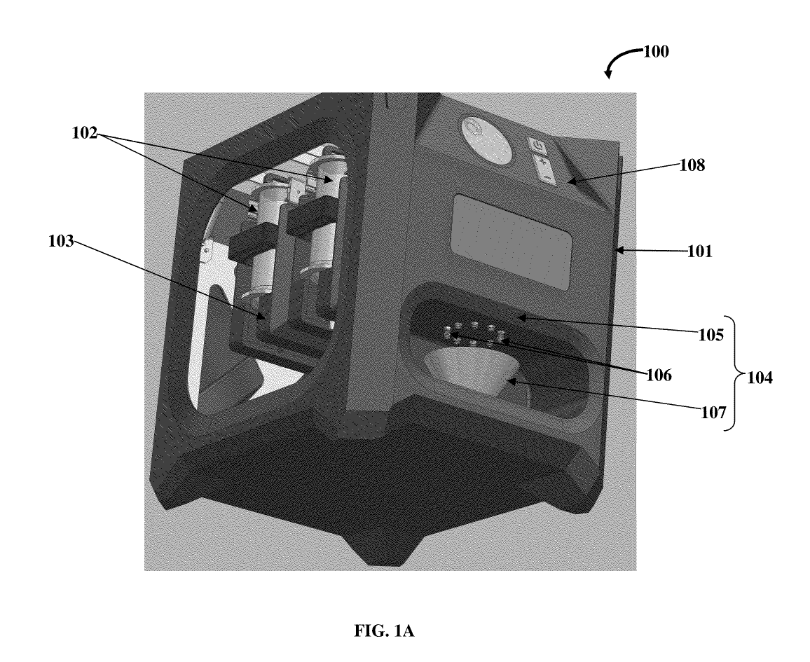

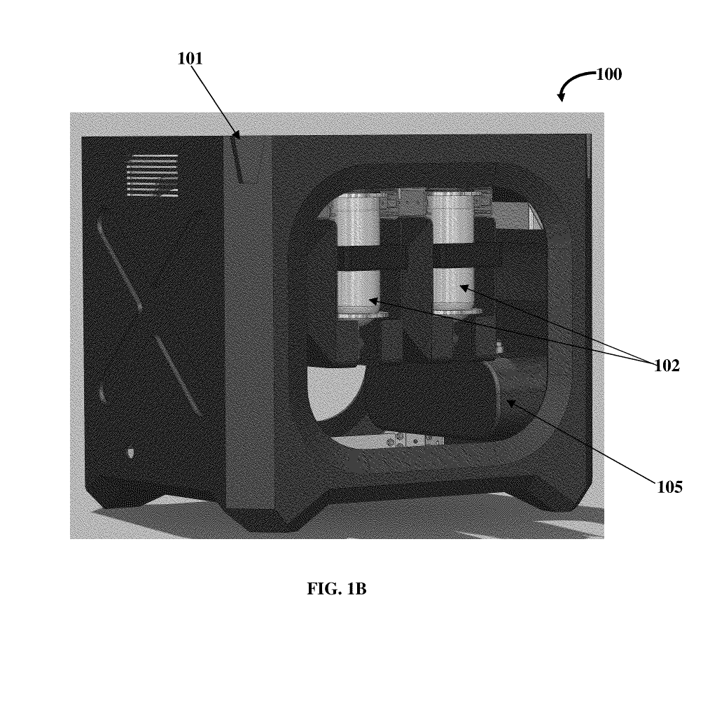

FIGS. 1A-1B exemplarily illustrates a bottom perspective view and a side perspective view of the multi-color fluid dispenser apparatus 100. The multi-color fluid dispenser apparatus 100 disclosed herein comprises generally cubical container 101, multiple cartridge members 102, a mixing unit 104, and a user interface 108. The cartridge members 102 are removably positioned on a holder 103 within the cubical container 101, where each cartridge member 102 is configured to store and dispense a different colored fluid via tube members 109 attached to each cartridge member 102. The mixing unit 104 is in communication with the cartridge members 102, and the mixing unit 104 comprises a dispenser head 105 and at least one mixing bowl 107.

The dispenser head 105 comprises multiple openings 106, where each opening 106 is attached to each tube member 109, and each opening 106 is configured to dispense a different colored fluid. The mixing bowl 107 is positioned below the dispenser head 105 the mixing bowl 107 is configured to receive one or more of the different colored fluids from one or more of the openings 106 of the dispenser head 105, where the mixing bowl 107 mixes the different colored fluids to generate new colored fluid. The user interface 108 is controlled by at least one processor and is in communication with the mixing unit 104. The user interface 108 is configured to facilitate a user to select the one or more different colored fluids, and dispense the one or more different colored fluids at predefined proportions via the dispenser head 105. The “user” mentioned here is, for example, is a licensed stylist/colorist with whom a customer with hair coloring requirement interacts.

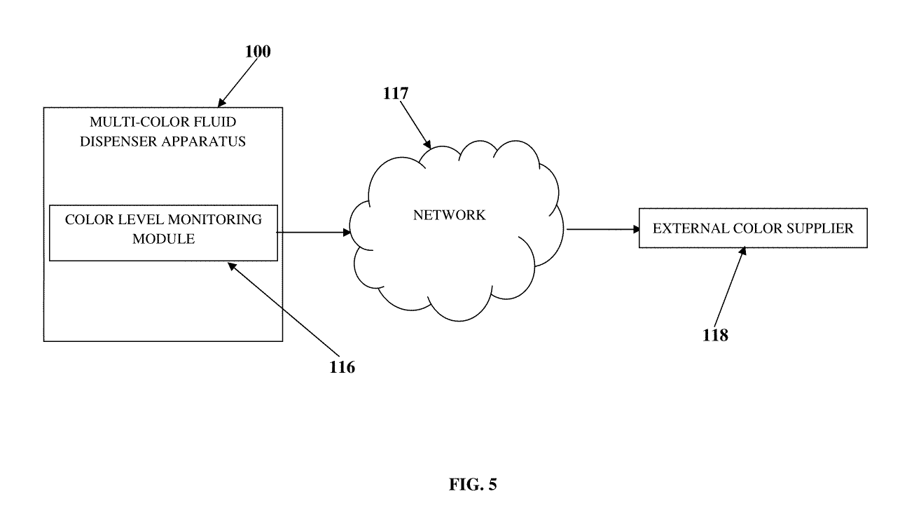

In an embodiment, the multi-color fluid dispenser apparatus 100 disclosed herein further comprises a database in communication with the user interface 108, where the database is configured to store information regarding personal details of the users and mixing proportions of the colored fluids of each of the respective users. In an embodiment, each mixing proportion of the colored fluids of each user is configured to be modified by the respective user. As disclosed in the detailed description of FIG. 5, in an embodiment, the multi-color fluid dispenser apparatus 100 disclosed herein further comprises a color level monitoring module 116 in communication with an external color supplier 118 via a network 117, where the color level monitoring module 116 transmits information regarding a low level of the colored fluids in one or more of the cartridge members 102 and places an order for the respective colored fluids to the external color supplier 118. In an embodiment, the mixing of the different colored fluids is performed in the mixing bowl 107 via one or combination of a vibration or a rotating impeller.

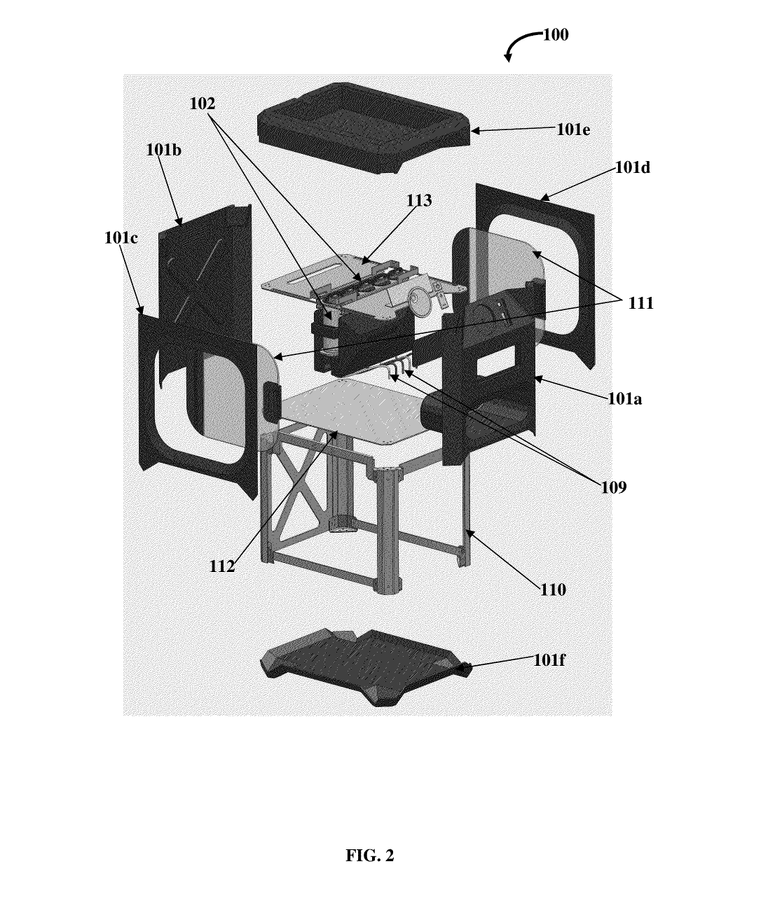

FIG. 2 exemplarily illustrates an exploded view of the multi-color fluid dispenser apparatus 100. The cubical container 101 is formed by assembling a front plate 101a, a rear plate 101b, side plates 101c and 101d, a top cover 101e, and a bottom cover 101f. The front plate 101a has openings 106 to allow the user to access the user interface 108 and further allows the user to see the cartridge members 102 and the tube members 109 extruding the selected different colored fluids. The support legs 110 provide support for the entire multi-color fluid dispenser apparatus 100. A set of glass seals 111 are also provided on the openings 106 defined on the side plates 101c and 101d, as shown in the FIG. 2. The glass seals 111 provide sealing from moisture and dust, and further allows the user to check the working condition of the cartridge members 102 and the tube members 109.

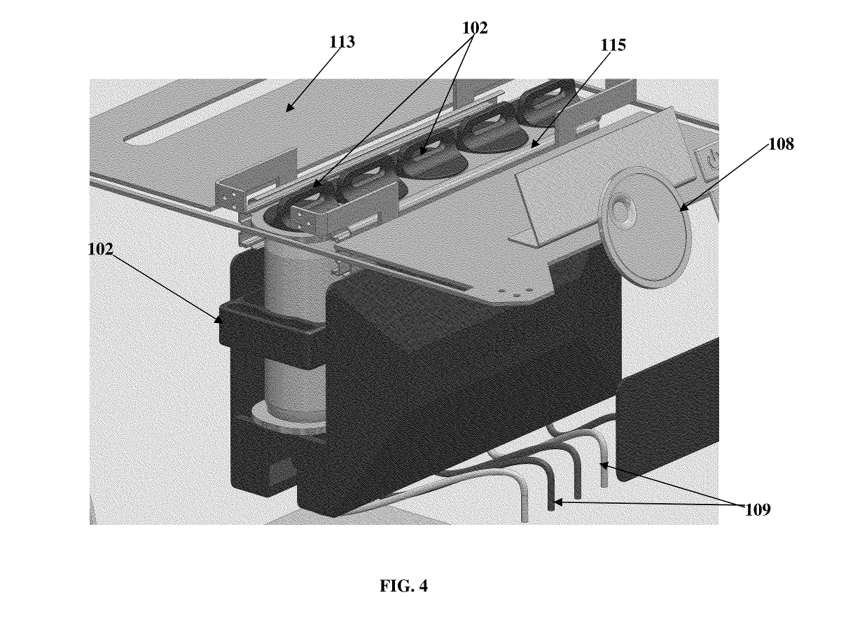

The cartridge members 102 attached with the tube members 109 are positioned on a base plate 112. An upper section of the cartridge members 102 are fastened in an array on an assembly plate 113 as disclosed in the detailed description of FIG. 4. In an embodiment, the multi-color fluid dispenser apparatus 100 disclosed herein further comprises a self-cleaning unit configured to clean the tube members 109 or the nozzle units. In an embodiment, the colored fluids are stored inside the cartridge members 102 in concentrated form.

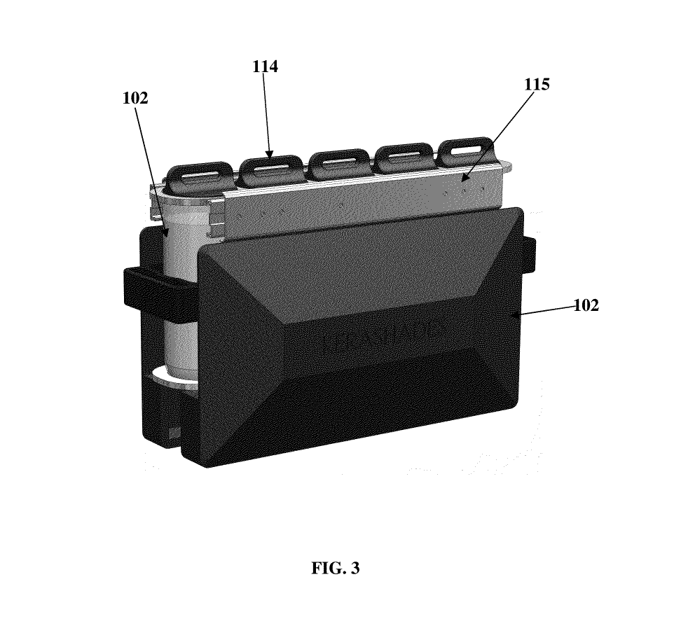

FIG. 3 exemplarily illustrates a perspective view of the cartridge members 102 positioned in the holder 103. The cartridge members 102 are, for example, for example, airtight aluminum storage tubes. The holder 103 arrange the cartridge members 102 in position. Handle members 114 are provided on the upper end of each of the cartridge members 102 so that a user can easily replace the cartridge members 102 after the level of colored fluid is low in any of the cartridge members 102. The cartridge members 102 are further stacked and fastened over the holder 103 via a flanged plate 115. In an embodiment, keratin is infused into the colored fluids stored in the respective cartridge members 102.

FIG. 4 exemplarily illustrates a top perspective view of the cartridges with the holder 103 and assembled below a top plate 113. The flanged plate 115 shown in FIG. 3 is fastened to the top plate 113. During maintenance, the user can disassemble the row of cartridge members 102 together by removing the top plate 113. The top plate 113 further provides the communication between the user interface 108 and the cartridge members 102. Further, in an example, the multi-color fluid dispenser apparatus 100 requires a user, such as a trained hair stylist and a licensed professional with experience in color applications. A customer can inform the about his/her requirements and the hairstylist will enter the data into the user interface 108, the entered data will be a formulation that's dedicated to a specific customer. According to the choice of the customer, he/she can make further changes in the formulation as per the requirement. The multi-color fluid dispenser apparatus 100 is for industry professionals creating an efficient, accurate dosage of the colors in order to reduce wastage of material and expenditure. The user can eliminate need for individual packaging as well.

As disclosed before in FIG. 1 and FIG. 2, the multi-color fluid dispenser apparatus 100 has a self-cleaning system, and an automatic re-ordering mechanism which avoids a requirement of purchase via phone or otherwise. This multi-color fluid dispenser apparatus 100 eliminates the task assessing missing shades or shades that are low, for example, out of about 70 available shades, since the multi-color fluid dispenser apparatus 100 mixes all desired possible shades by using keratin infused in all the coloured fluids, i.e. only for primary and secondary colored fluids. This makes it easy for the hair colorist/stylist to choose and dispense without having to mix manually or work around missing colored fluids. These colored fluids are dispensed in concentrated form and thus do not consume a large capacity of the cartridge members 102 and are infused with keratin.

The prior arts offer the base colors for their whole spectrum of colors, and just dispense the base colors into a tube that is available through drugstore vending machines, whereas, in an exemplary embodiment, the multi-color fluid dispenser apparatus 100 is mixes colors from a base of 6 colors of only primary and secondary colors. Further every color in the multi-color fluid dispenser apparatus 100 is infused with keratin a smoothing treatment, thus minimizing the effects of drying agents in color and creating a noticeable sheen. Furthermore, although the multi-color fluid dispenser apparatus 100 automatically reorders low pigment in the cartridge members 102, the cartridge members 102 that need to be refilled are minimum in number unlike the vending machine which probably carries a minimum of 30 base colors that are mixed and tubed to get desired color.

FIG. 5 exemplarily illustrates a schematic diagram of the working of the color level monitoring module 116 and the external color supplier 118 via the network 117. As disclosed in the detailed description of FIG. 1, the multi-color fluid dispenser apparatus 100 further comprises a color level monitoring module 116 in communication with an external color supplier 118 via a network 117. The color level monitoring module 116 transmits information regarding a low level of the colored fluids in one or more of the cartridge members 102 and places an order for the respective colored fluids to the external color supplier 118. In an example, when the level of colored fluid or the coloring pigment becomes low due to usage or any minor leakage, the color level monitoring module 116 detects the low level of pigment in the respective cartridge member 102 or a combination of cartridge members 102. Thereafter the color level monitoring module 116 segregates a data of the quantity of coloring fluid needed to refill the cartridge member 102 and transmits the information to the external color supplier 118 via a network 117. The network 117 is, for example, internet or intranet. The external color supplier 118 is, for example, a vendor color supplier with a server to interact with the color level monitoring module 116 of the multi-color fluid dispenser apparatus 100.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A multi-color fluid dispenser apparatus comprising:
a generally cubical container;
a plurality of cartridge members removably positioned on a holder within the cubical container, each cartridge member configured to store and dispense a different colored fluid via tube members attached to each cartridge member;
a mixing unit in communication with the cartridge members, the mixing unit comprising:
a dispenser head comprising a plurality of openings, wherein each opening is attached to each tube member, and each opening is configured to dispense a different colored fluid; and
at least one mixing bowl positioned below the dispenser head the mixing bowl configured to receive one or more of the different colored fluids from one or more of the openings of the dispenser head, wherein the mixing bowl mixes the different colored fluids to generate new colored fluid;
a user interface controlled by at least one processor in communication with the mixing unit, the user interface configured to facilitate a user to select the one or more different colored fluids and dispense the one or more different colored fluids at predefined proportions via the dispenser head.

2. The multi-color fluid dispenser apparatus of claim 1, further comprises a database in communication with the user interface, wherein the database is configured to store information regarding personal details of the users and mixing proportions of the colored fluids of each of the respective users.

3. The multi-color fluid dispenser apparatus of claim 2, wherein each mixing proportion of the colored fluids of each user is configured to be modified by the respective user.

4. The multi-color fluid dispenser apparatus of claim 1, further comprises a color level monitoring module in communication with an external color supplier via a network, wherein the color level monitoring module transmits information regarding a low level of the colored fluids in one or more of the cartridge members and places an order for the respective colored fluids to the external color supplier.

5. The multi-color fluid dispenser apparatus of claim 2, further comprising a self-cleaning unit configured to clean the tube members.

6. The multi-color fluid dispenser apparatus of claim 2, wherein the colored fluids are stored inside the cartridge members in concentrated form.

7. The multi-color fluid dispenser apparatus of claim 2, wherein keratin is infused into the colored fluids stored in the respective cartridge members.

8. The multi-color fluid dispenser apparatus of claim 1, wherein the mixing of the different colored fluids is performed in the mixing bowl via one or combination of a vibration and a rotating impeller.
